(19) United States
(12) Patent Application Publication
(10) Pub. No.: US 2025/0293418 A1
(43) Pub. Date: Sep. 18, 2025

(54) RESONANT ELEMENT, AND RESONANT UNIT AND FILTER COMPRISING THE SAME

(71) Applicant: Telefonaktiebolaget LM Ericsson (publ), Stockholm (SE)

(72) Inventors: Xiaolong Su, Beijing (CN); Qixing Chen, Beijing (CN); Xueyuan Zhang, Beijing (CN); Weidong Wang, Beijing (CN); Lei Sun, Beijing (CN)

(21) Appl. No.: 18/860,403

(22) PCT Filed: Apr. 26, 2022
(86) PCT No.: PCT/CN2022/089363

§ 371 Date: Oct. 25, 2024

(51) Int. Cl. H01P 1/208; H01P 7/06

(52) U.S. Cl. CPC H01P 1/208; H01P 7/06

(57) ABSTRACT

A one-piece resonant element (100, 100′) for a filter (10, 10′), comprising a main body (100-12, 100′-12) which comprises an elongate middle part (100-1, 100′-1) and resonant end parts (100-2, 100′-2) provided on both ends of the middle part (100-1, 100′-1), wherein the one-piece resonant element further comprises a cross-coupling arm (100-3, 100′-3, 100′-3i) extending integrally from the middle part (100-1, 100′-1) and configured for creating inductive or capacitive cross-coupling with a resonator that is located on a signal transmission path of the filter. A resonant unit (200, 200′) comprising above-said resonant element and a filter (10, 10′) comprising the above said resonant element or resonant unit.

### TECHNICAL FIELD

The present disclosure generally relates to the technical field of communication device, and more particularly, to a resonant element, and a resonant unit and a filter comprising the same.

### BACKGROUND

This section introduces aspects that may facilitate better understanding of the present disclosure. Accordingly, the statements of this section are to be read in this light and are not to be understood as admissions about what is in the prior art or what is not in the prior art.

With the development of 5G communication, MIMO (multiple-input and multiple-output) technology is widely used in Sub-6GHZ base station product. The filter is an important component to build a multi-channel AAS (active antenna system) radio system. How to improve the RF (radio frequency) performance of the filter, and how to reduce the size, weight, and cost of the filter are important considerations for the radio product design.

In recent years, in the research of low loss filter scheme, a sheet metal filter attracts more and more attention and has been widely used in the AAS system to realize a small sized radio, because the sheet metal filters are much better than CWG (ceramic waveguide) filters in a same size in terms of insertion loss and reliability. Also, for improving production efficiency, the sheet metal filter is required to be simple in structure which needs fewer devices or process steps or can be manufactured in an easy and efficient manner.

Most of existing sheet metal filters adopt a single cavity structure with an independent resonator as a separate component. It is required to connect the cavity and the resonator together by a separate step during manufacturing. They thus have disadvantages of low consistency and reliability, complex production and high cost, and low debugging efficiency.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for obtaining a miniaturized filter with high debugging and production efficiency and also at reduced cost.

According to a first aspect of the disclosure, there is provided a one-piece resonant element for a filter, comprising a main body which comprises an elongate middle part and resonant end parts provided on both ends of the middle part. The one-piece resonant element further comprises a cross-coupling arm extending integrally from the middle part and configured for creating inductive or capacitive cross-coupling with a resonator that is located on a signal transmission path of the filter.

In an embodiment of the disclosure, the main body of the one-piece resonant element is substantially flat.

In an embodiment of the disclosure, the resonant end parts each have a thickness greater than or equal to a thickness of the middle part.

In an embodiment of the disclosure, the cross-coupling arm extends from a widthwise end side of the middle part of the resonant element.

In an embodiment of the disclosure, a free end of the cross-coupling arm has a bending part which is configured to provide a coupling face for coupling with the resonator.

In an embodiment of the disclosure, a free end of the cross-coupling arm is configured to provide a coupling end surface for coupling with the resonator.

In an embodiment of the disclosure, the resonant end parts of the resonant element each comprise a widened portion relative to the middle part.

In an embodiment of the disclosure, at least one widened portion is provided with a hole for receiving a tuning screw on its planar side.

In an embodiment of the disclosure, a bending lug is provided on at least one widthwise end of the widened portion of one resonant end part and extends substantially in a direction of the other resonant end part.

In an embodiment of the disclosure, at least one of the resonant end parts is provided with a planar extension portion in its end area, the planar extension portion extending in a plane substantially perpendicular to a lengthwise direction of the middle part for providing a coupling surface.

In an embodiment of the disclosure, the resonant element is made of metal or surface metallized.

According to a second aspect of the disclosure, there is provided a resonant unit comprises at least two one-piece resonant elements as indicated in the above. A coupling gap is formed between a cross-coupling arm of a first resonant element and a cross-coupling arm of a second resonant element, or the cross-coupling arms of the first resonant element and the second resonant element are, as separate arms, connected into one, or defined by one single one-piece arm integrally formed with the main bodies of the first and second resonant elements.

In an embodiment of the disclosure, the main bodies of the first resonant element and the second resonant element are in basically the same shape.

In an embodiment of the disclosure, the main bodies of the first resonant element and the second resonant element are placed in basically one and the same plane.

In an embodiment of the disclosure, the coupling gap is defined between coupling surfaces that are provided by bending parts at free ends of the cross-coupling arms and located opposite to each other, with bending parts extending in a same direction or in different directions.

In an embodiment of the disclosure, the coupling gap is defined between side surfaces that are opposite to each other, of the cross-coupling arms.

According to a third aspect of the disclosure, there is provided a filter, comprising: a filter frame in which an accommodation space is formed; partition walls provided in the accommodation space and dividing the accommodation space into resonant cavities; at least one above-said resonant element or at least one above-said resonant unit arranged in the accommodation space in such a manner that each resonant element functions as two resonators that are adjacent to each other along the signal transmission path, with its middle part extending across a partition wall between two adjacent resonant cavities for the two resonators.

In an embodiment of the disclosure, an isolation channel for receiving cross-coupling arms is defined by partition walls.

In an embodiment of the disclosure, the resonant element is supported by a partition wall across which it extends.

In an embodiment of the disclosure, an attaching means is provided on the middle part of the resonant element for attaching the middle part onto the partition wall across which the middle part extends.

In an embodiment of the disclosure, the resonant element is integrally formed with the partition wall across which it extends.

In an embodiment of the disclosure, the filter comprises an input connector and an output connector, the input connector and/or output connector comprises a metal block attached to a wall of the filter frame, and a resonant end part that is located adjacent to the metal block is configured to have a planar surface adapted for coupling with a corresponding surface of the metal block.

According to the present disclosure, it allows a highly integrated low loss solution for producing a filter, by using multiple resonant cavities sharing a single resonant element to achieve different coupling, and allows for an integration of the resonator structure and the filter frame, for example, by die casting. The filter can be manufactured easily to have inductance or capacitance cross-coupling in a manner as desired, with reduced number of independent components and improved consistency. Also, the filter can be miniaturized with low weight, low loss, low cost, high efficiency and reliability. High debugging and production efficiency can be obtained for the filter of the present disclosure, due to the high integration of the resonator structures. The filter of the present disclosure can be used in multichannel input-output base station products such as AAS systems or AAS Radio which requires one or more filter units.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 shows a partially exploded view of a sheet metal filter according to a first embodiment of the present disclosure;

FIG. 2 shows a perspective view of the sheet metal filter according to the first embodiment of the present disclosure, wherein a top cover is removed and resonant units therein are taken out of the filter frame for better illustration;

FIG. 3 shows a top view of the sheet metal filter according to the first embodiment of the present disclosure, having a first example of main body for the resonant elements or resonant units therein;

FIG. 4 shows a corresponding coupling form between resonant cavities in the sheet metal filter according to the first embodiment of the present disclosure;

FIG. 5 shows a waveform of the filter according to the first embodiment of the present disclosure;

FIG. 6 shows a top view of a first part of the filter according to the first embodiment of the present disclosure;

FIG. 7 shows a perspective view of a first resonant unit of the filter according to the first embodiment of the present disclosure;

FIG. 8 shows electric field directions associated with two resonators between which a capacitive cross-coupling is formed, in the first part of the filter according to the first embodiment of the present disclosure;

FIG. 9 shows a perspective view of a first example of the first resonant unit of the filter according to the first embodiment of the present disclosure;

FIG. 10 shows a perspective view of a second example of the first resonant unit of the filter according to the first embodiment of the present disclosure;

FIG. 11 shows a perspective view of a third example of the first resonant unit of the filter according to the first embodiment of the present disclosure;

FIG. 12 shows a perspective view of a fourth example of the first resonant unit of the filter according to the first embodiment of the present disclosure;

FIG. 13 shows a top view of a second part of the filter according to the first embodiment of the present disclosure;

FIG. 14 shows electric field directions associated with two resonators between which an inductive cross-coupling is formed, in the second part of the filter according to the first embodiment of the present disclosure;

FIG. 15 shows a perspective view of the filter according to the first embodiment of the present disclosure;

FIG. 16 shows electric field directions associated with adjacent resonators of the first part and the second part between which a main coupling is formed, in the filter according to the first embodiment of the present disclosure;

FIG. 17 shows a perspective view of a filter according to a second embodiment of the present disclosure, having a second example of a main body for the resonant elements or resonant units therein, wherein the top cover is removed and the resonant units therein are taken out of the filter frame for better illustration;

FIG. 18 shows a perspective view of a third example of a main body for the resonant elements or resonant units;

FIG. 19 shows a perspective view of a fourth example of a main body for the resonant elements or resonant units;

FIG. 20 shows a perspective view of a fifth example of a main body for the resonant elements or resonant units; and

FIG. 21 shows a perspective view of a sixth example of a main body for the resonant elements or resonant units.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

FIG. 1 shows a sheet metal filter 10 of the present disclosure with both a top cover 50 and a bottom plate 60 being removed in order to clearly show resonator structures therein. The filter 10 comprises a filter frame 20 in which an accommodation space is formed. Partition walls 30 are provided in the accommodation space, dividing the accommodation space into resonant cavities. Resonators provided in resonant cavities function to transmit signal therebetween. Thereby in the filter there is a main signal transmission path defined by main coupling between adjacent resonators. The filter frame 20, the top cover 50 and the bottom plate 60 may be made of sheet metal.

As shown in FIGS. 1-3, the filter 10 comprises a first part 10-1 in which a first resonant unit 200 is provided, and a second part 10-2 in which a second resonant unit 200′ is provided. The first part 10-1 is coupled with the second part 10-2. The first resonant unit 200 comprises two resonant elements 100, i.e., a first resonant element and a second resonant element, arranged in a pair. Each of the first and second resonant elements is a one-piece element, comprising a main body 100-12 having an elongate middle part 100-1 and resonant end parts 100-2 provided on both ends of the middle part. Each of the first and second resonant elements further comprises a cross-coupling arm 100-3 extending integrally from the middle part 100-1 of the main body 100-12.

As clearly shown in FIG. 3, in the first part 10-1 of the filter, the paired first and second resonant elements of the first resonant unit 200 are arranged in parallel in such a manner that each resonant element 100 functions as two resonators that are adjacent to each other along the signal transmission path, with its middle part 100-1 extending across a partition wall 30 between two adjacent resonant cavities for the two resonators. With the partition walls 30, the accommodation space in the first part 10-1 are divided into four resonant cavities in a 2×2 array, each resonant cavity having a resonator provided therein and coupled with an adjacent resonator by either a coupling window or a conductor. An isolation channel 30-3 for receiving the cross-coupling arms 100-3 is defined by partition walls 30. Within this isolation channel 30-3, the cross-coupling arm 100-3 of the first resonant element extends towards the cross-coupling arm 100-3 of the second resonant element such that a coupling gap 100-31 and therefore a structural capacitor is formed between free ends of the cross-coupling arms 100-3 for realizing capacitive cross-coupling between resonators that are arranged diagonally and not adjacent to each other along the signal transmission path. The strength of the capacitive coupling is determined based on the size and shape of the coupling gap 100-31.

In the second part 10-2 of the filter 10, the second resonant unit 200′ is embodied as a generally “Z” shaped one-piece member, comprising two elongate main bodies 100′-12 arranged in parallel with a single one-piece arm 100′-3i provided therebetween. The single one-piece arm 100′-3i can also be embodied as two cross-coupling arms 100′-3 each extending from respective elongate main body and connected, as separate arms, into one. That is to say, in the second resonant unit 200′, there are two resonant elements 100′ which are similar to the paired resonant elements 100 of the first resonant unit 200, but are connected to each other at opposing ends of the cross-coupling arms 100′-3. Or rather, the cross-coupling arms 100′-3 of the two resonant elements 100′ of the second resonant unit 200′ are defined by the single one-piece arm 100′-3i integrally formed with the main bodies 100′-12 or with the middle parts 100′-1 of the main bodies 100′-12. The two resonant elements 100′ of the second resonant unit 200′ are arranged in such a manner that each resonant element 100′ functions as two resonators that are adjacent to each other along the signal transmission path, with its middle part 100′-1 extending across a partition wall 30 between two adjacent resonant cavities for the two resonators. Similar to the first part 10-1, the second part 10-2 of the filter 10 has an accommodation space therein divided by partition walls into four resonant cavities in a 2×2 array. Each resonant cavity has a resonator provided therein and coupled with an adjacent resonator by either a coupling window or a conductor. An isolation channel 30′-3 for receiving the single one-piece arm 100′-3i is defined by partition walls. Within this isolation channel, the single one-piece arm 100′-3i extends such that inducive cross-coupling is formed between resonators that are arranged diagonally and not adjacent to each other along the signal transmission path.

As shown in FIG. 3, in the first part 10-1 of the filter 10, a first resonator 1, a second resonator 2, a third resonator 3 and a fourth resonator 4 are arranged in order along a first U-shaped transmission signal path, and in the second part 10-2 of the filter 10, a fifth resonator 5, a sixth resonator 6, a seventh resonator 7 and an eighth resonator 8 are arranged in order along a second U-shaped transmission signal path.

Also referring to FIG. 3, the first part 10-1 of the filter 10 comprises an input connector which has an input metal block 40a attached to a wall of the filter frame 20 and located adjacent to the first resonator 1 of the first part 10-1 for inputting a signal. The second part 10-2 of the filter 10 comprises an outlet connector which has an outlet metal block 40b attached to a wall of the filter frame and located adjacent to the eighth resonator 8 for outputting a signal.

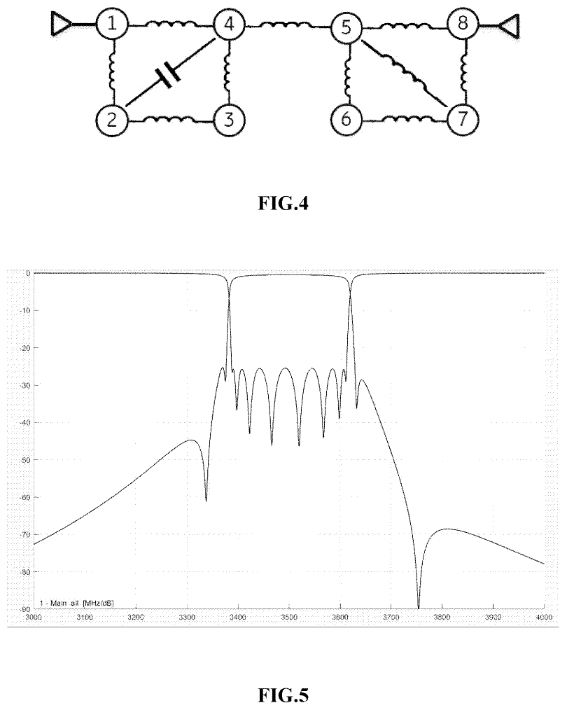

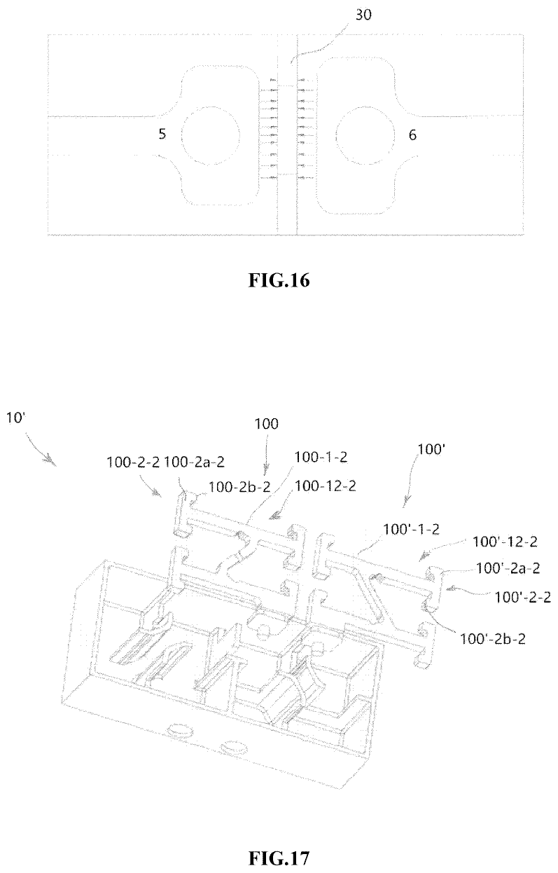

The fourth resonator 4 and the fifth resonator 5 are coupled to each other by a coupling window in the partition wall 30 provided between two resonant cavities associated with the fourth resonator 4 and the fifth resonator 5. The first part 10-1 and the second part 10-2 are coupled by this main coupling between the fourth resonator 4 and the fifth resonator 5 (see FIG. 15), with electric fields formed in an area of opposing surfaces of the fourth resonator 4 and the fifth resonator 5 being in a same direction (see FIG. 16). Therefore, the first U-shaped signal transmission path and the second U-shaped signal transmission path are connected into one signal transmission path, i.e., the main signal transmission path of the filter 10, as shown in FIG. 3. The coupling form between all the resonant cavities is shown accordingly in FIG. 4. Also, from the wave form of the filter as shown in FIG. 5, it can be seen the filter of the present disclosure exhibits a good electrical performance.

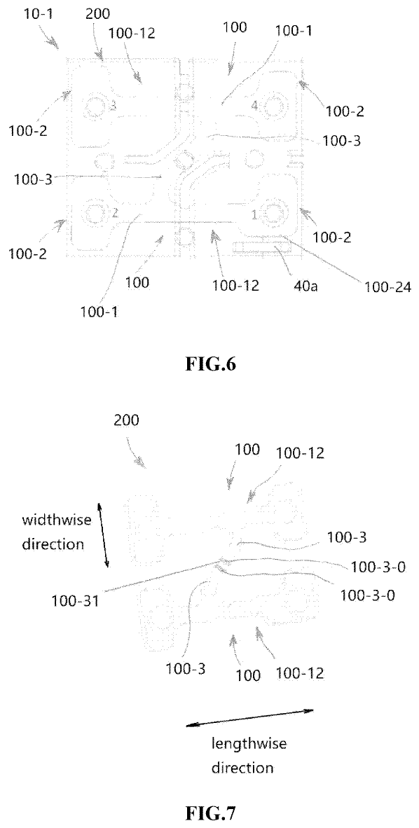

For clearly showing the configuration of the resonant element 100, 100′, i.e., the basic element for the first resonant unit or the basic portion of the second resonant unit, FIG. 6 shows a top view of the first part 10-1 alone, with the second part 10-2 removed directly, and FIG. 7 shows a perspective view of the first resonant unit 200 of the first part with the filter frames and partition walls removed directly. From FIG. 7, it can be seen that the one-piece resonant elements 100 are arranged in a pair, with ends of the cross-coupling arms 100-3 facing to each other and spaced from each other by a coupling gap 100-31. In the embodiment as shown in FIG. 7, the main body 100-12 of each one-piece resonant element is substantially flat. Main bodies of the one-piece resonant elements arranged in a pair may be placed in substantially one and same horizontal plane. The main bodies 100-12 may be configured in basically the same shape. Cross-coupling arms 100-3 each may extend from a widthwise end side of the middle part, for example, in the same horizontal plane as the plane where main bodies lie. At the free ends of the cross-coupling arms arranged in a pair, coupling end surfaces 100-3-0 are provided, facing each other along a direction perpendicular to the coupling end surfaces.

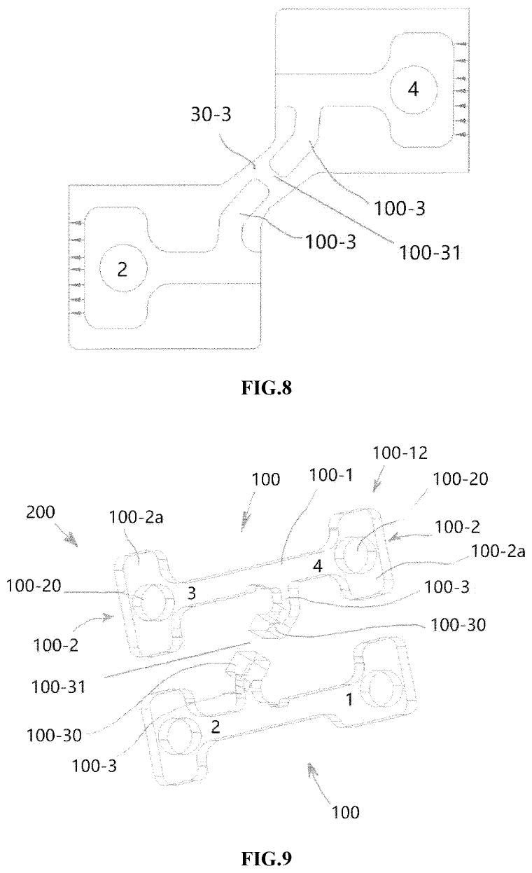

FIG. 8 shows that electric fields created on end surfaces of the second resonator 2 and the fourth resonator 4 are in different directions.

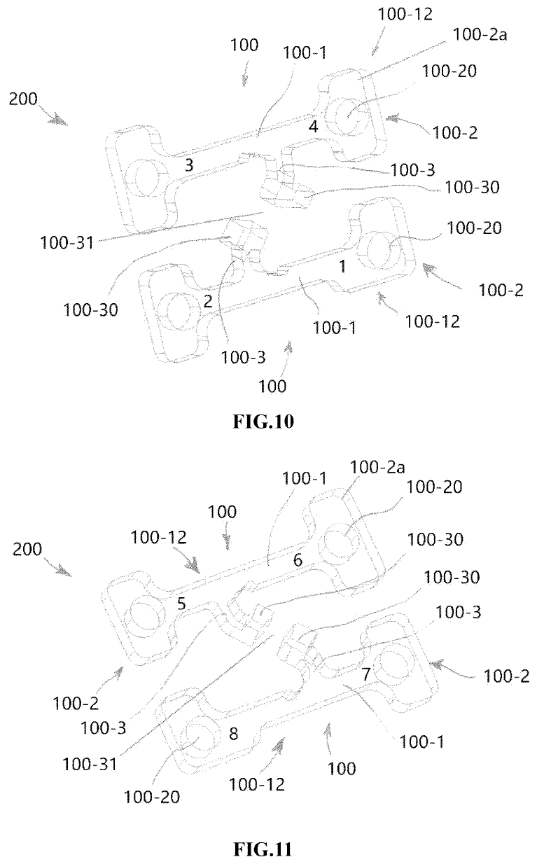

In the embodiment of the first resonant unit 200 shown in FIG. 9, each cross-coupling arm 100-3 has a bending part 100-30 provided at its free end such that a sufficient coupling face may be provided by the bending part and made available for realizing capacitive cross-coupling strength as required. The bending parts 100-30 of the cross-coupling arms 100-3 may be obtained by bending at the ends of the cross-coupling arms 100-3 in same or different directions. For example, the bending parts 100-30 as shown in FIG. 9 extend in a same direction such that their coupling faces provided thereon are spaced by a coupling gap 100-31, located opposite to each other and substantially aligned with each other along a direction perpendicular to the coupling faces. While, in the example of the first resonant unit 200 shown in FIG. 10, the bending parts 100-30 extend in different directions. Although FIGS. 9 and 10 show that the cross-coupling arms 100-3 are configured for realizing cross-coupling between the second resonator 2 and the fourth resonator 4, it can be understood that, the location of extension bases (or, roots) for the cross-coupling arms 100-3 may be selected, based on which two resonators are matched to be coupled. For example, as shown in FIG. 11, one cross-coupling arm has its extension base located in a region of the fifth resonator 5, the other cross-coupling arm has its extension base located in a region of the seventh resonator 7.

As a variant of the first resonant unit shown in FIG. 12, the cross-coupling arms 100-3 are coupled by means of a coupling gap 100-31 defined between side faces that are opposite to each other, of the cross-coupling arms. A capacitive coupling is thereby formed between the fifth resonator 5 and the seventh resonator 7.

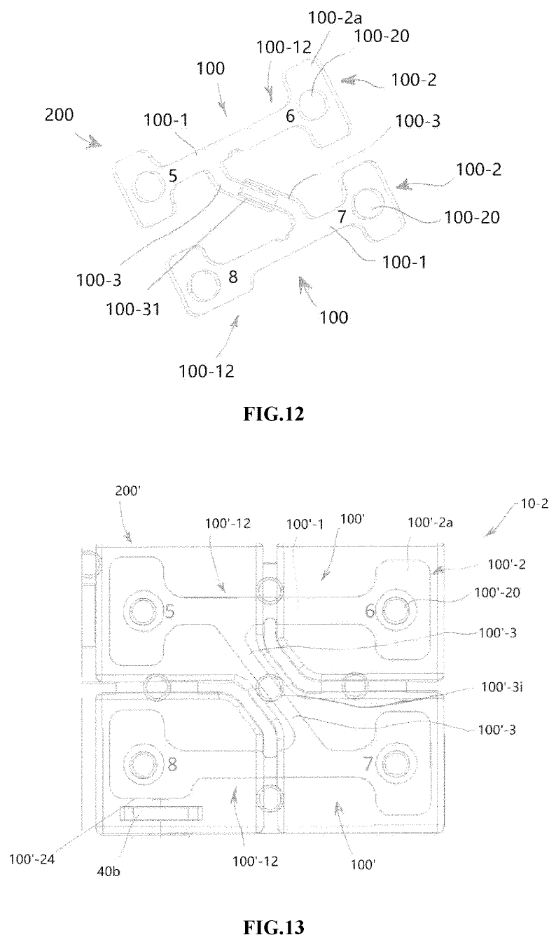

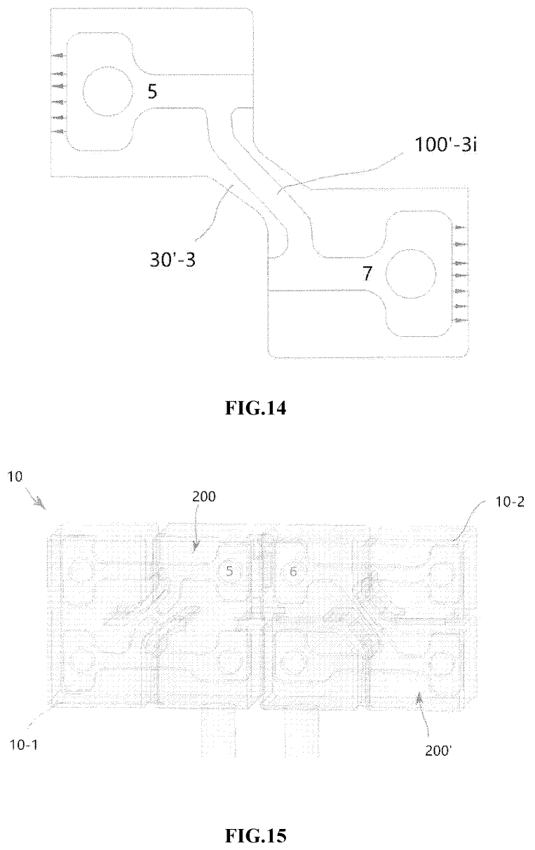

In the second part 10-2 of the filter 10, the second resonant unit 200′ is provided in such a manner (as shown in FIG. 13) that electric fields formed in the area of the fifth resonator 5 and the seventh resonator 7 have same directions (as shown in FIG. 14). Although the second resonator unit 200′ is configured in the form of a one-piece member, it can also be embodied as two resonant elements with their cross-coupling arms being connected into one piece. Therefore, the main bodies 100′-12 of the second resonator unit 200′ may be configured in the same manner as those for the resonant elements 100 of the first resonator unit 200.

Hereinbelow description will be made on the configuration of the main bodies of basic resonant elements of the first and second resonator units 200, 200′.

### A First Example of the Main Body

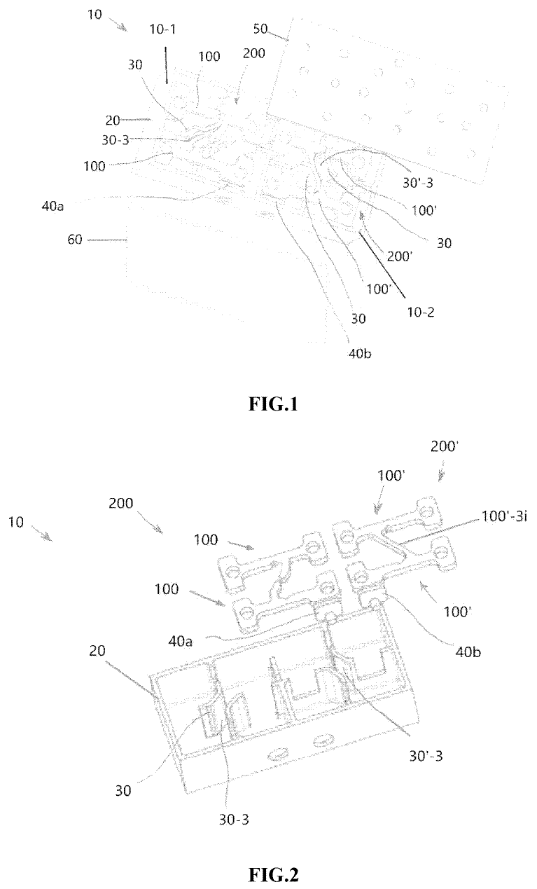

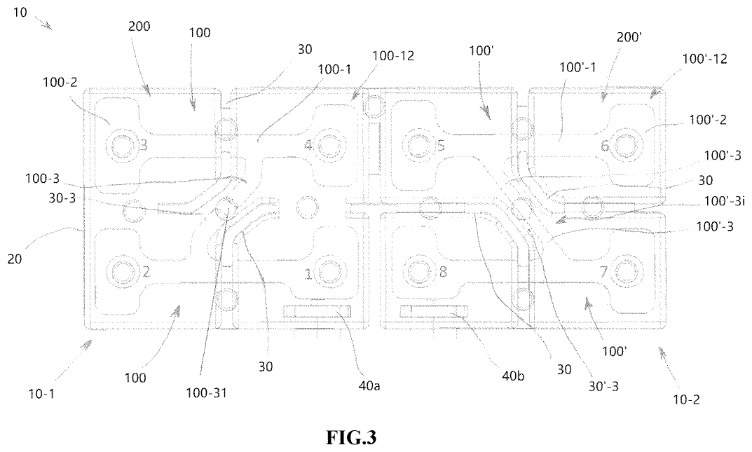

As shown in FIGS. 2-3, 7 and 9-13, the main body 100-12, 100′-12 of the resonant element 100, 100′ is substantially flat, with the resonant end parts 100-2, 100′-2 having a thickness equal to a thickness of the middle part 100-1, 100′-1. The flat resonant element 100, 100′ is supported by the partition wall 30 and placed horizontally in the accommodation space of the filter 10.

The resonant end parts 100-2, 100′-2 of the resonant element 100, 100′ each comprise a widened portion 100-2a, 100′-2a relative to the middle part 100-1, 100′-1.

At least one widened portion 100-2a, 100′-2a is provided with a hole 100-20, 100′-20 for receiving a tuning screw on its planar side. The provision of the holes makes it possible to have the frequency tuned flexibly and also to reduce the total weight of the filter.

The width of the widened portion 100-2a, 100′-2a may be designed according to its requirement on the coupling with surrounding walls or surfaces. For example, as shown in FIGS. 6 and 13, due to the insertion of the input metal block 40a and the outlet metal block 40b, the widened portions 100-2a, 100′-2a associated with the first resonator 1 and the eighth resonator 8 are designed to have smaller width than other widened portions, but still each configured to provide a planar surface 100-24, 100′-24 adapted for coupling with a corresponding surface of the metal block.

### A Second Example of the Main Body

FIG. 17 shows a second example of the main body 100-12-2, 100′-12-2 for the resonant element of a filter 10′, which differs from the first example mainly in the design of the resonant end part 100-2-2, 100′-2-2. Specifically, in the second example, the resonant end part 100-2-2, 100′-2-2 has a widened portion 100-2a-2, 100′-2a-2 having a width greater than the width of the middle part 100-1-2, 100′-1-2. But the widened portion 100-2a-2, 100′-2a-2 is embodied as an elongate portion extending in the widthwise direction, without having a sufficient length (along the lengthwise direction of the middle part) for providing an area for the provision of holes for receiving tuning screws. At least one bending lug 100-2b-2, 100′-2b-2 is provided on at least one widthwise end of the widened portion 100-2a-2, 100′-2a-2 of one resonant end part and extends substantially in a direction of the other resonant end part. With the provision of bending lugs, it is possible to provide additional coupling with surrounding walls of the resonant cavities or with surrounding resonators via coupling windows, thus allowing effectively reducing the frequency of the resonant cavity associated therewith and therefore the size of the filter as well.

### A Third Example of the Main Body

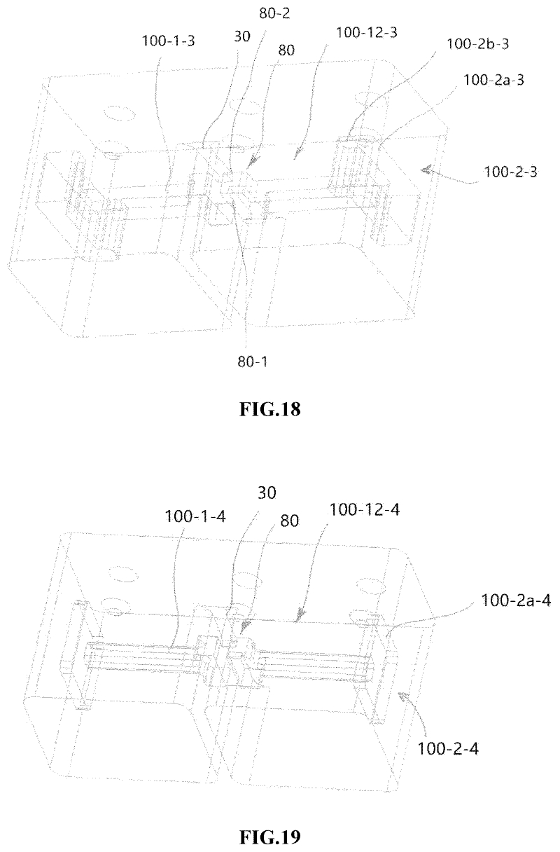

As shown in FIG. 18, the main body 100-12-3 according to the third example comprises resonance end parts 100-2-3 having a greater thickness than the thickness of the middle part 100-1-3. The widened portions 100-2a-3 provided at ends of the resonant end parts 100-2-3 also have bending lugs 100-2b-3 provided at their widthwise ends and extending substantially along the lengthwise direction of the middle part. Because of the increased thickness of resonance end parts (compared with the second example), more coupling surfaces are provided for coupling with surrounding walls of the resonant cavities and therefore the frequency of the resonant cavity concerned can be reduced and the size of the filter thus made can be reduced as well.

Additionally or optionally, an attaching means 80 is provided on the middle part 100-1-3 of the main body 100-12-3 for attaching the middle part onto a partition wall 30 across which the middle part extends. The attaching means 80 may be embodied in the form of a clamping recess 80-1, 80-2 for receiving an edge of the partition wall. As shown in FIG. 18, a clamping recess is provided on each widthwise side of the middle part. When the middle part 100-1-3 is attached to the partition wall 30, a neck portion defined between the two clamping recess is engaged into a positioning groove provided on the upper edge of the partition wall and sandwiched between the side edges of the positioning groove which also engage respectively in the clamping recess on each widthwise side. In this way, the middle part 100-1-3 is supported by the partition wall 30 across which the middle part extends, and cannot move either in the lengthwise direction or in the widthwise direction of the middle part, with respect to the partition wall.

Although it is shown in FIG. 18 that the attaching means are embodied as a clamping recess, it can be understood that, other forms of the attaching means are also possible, for example, a snap-in connector, as long as the partition walls to which the resonant elements are attached are provided with corresponding means for cooperation with the attaching means.

### A Fourth Example of the Main Body

As shown in FIG. 19, at least one of the resonant end parts 100-2-4 is provided with a planar extension portion 100-2a-4 in its end area. The planar extension portion 100-2a-4 extends in a plane substantially perpendicular to the lengthwise direction of the middle part, for providing a coupling face for coupling with surrounding walls of the resonant cavity where it is positioned. The planar extension portion 100-2a-4 may be configured to have a cross-sectional area greater than that of the middle part. In this way, the coupling face provided by the planar extension portion can be made as big as possible, such that the coupling with the surrounding wall of the resonant cavity is increased, and the frequency of the resonant cavity concerned and the size of the filter can be reduced.

Optionally or additionally, the middle part 100-1-4 of the main body 100-12-4 is attached to the partition wall 30 by means of the engagement between an attaching means 80 provided on the middle part and edges of a positioning groove provided on the partition wall.

### A Fifth Example of the Main Body

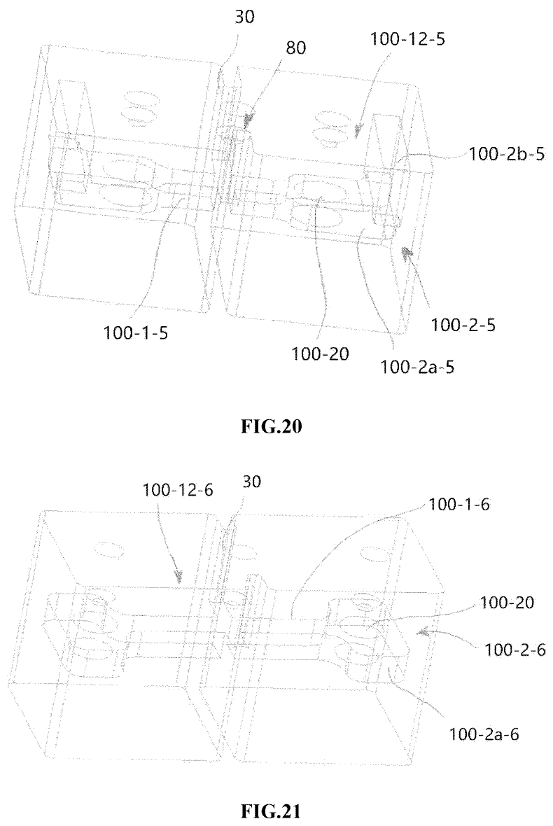

As shown in FIG. 20, the resonant end parts 100-2-5 of the main body 100-12-5 according to the fifth example each comprise a widened portion 100-2a-5 having a width greater than the middle part. The widened portions 100-2a-5 each are provided with a hole 100-20 for receiving therein a tuning screw. The resonant end parts 100-2-5 each are provided with a planar extension portion 100-2b-5 which is positioned at the lengthwise end of the widened portion 100-2a-5 and extends in a plane substantially perpendicular to the lengthwise direction of the middle part 100-1-5. In the embodiment shown in FIG. 20, the planar extension portion 100-2b-5 extends mainly on a side of the main body 100-12-5 facing the top cover from which the tuning screws are inserted into resonant cavities. With this configuration, an inward facing surface of the planar extension portion 100-2b-5 may be provided as a tuning surface cooperating with a tuning screw inserted into a region in proximity to or partially surrounded by the inward-facing surface of the planar extension portion.

Additionally or optionally, the middle part 100-1-5 is provided with an attaching means 80 in the form of a clamping recess opening downwards. When attaching the middle part onto the partition wall, the bottom edge of the positioning groove in the partition wall 30 is engaged into the clamping recess, such that the middle part 100-1-5 straddle across the partition wall and is fixedly positioned by side walls of the clamping recess.

### A Sixth Example of the Main Body

FIG. 21 shows a sixth example of the main body 100-12-6 in which the middle part 100-1-6 is integrally formed with the partition wall 30 across which it extends. The middle part (or the whole resonant element) and the partition wall may be formed into one piece, for example, by die casting of sheet metal. During the die casting, both the main body (i.e., the resonant end parts and the middle part) and the cross-coupling arms or single one-piece arm associated can be formed integrally in one step. Holes 100-20 for receiving tuning screws can be provided in the widened portion 100-2a-6 of the resonant end parts 100-2-6, for example, by punching.

For better illustration of the middle part, cross-coupling arms are removed from FIGS. 18-21. It can be readily understood that, a cross-coupling arm (or a single-one-piece arm) is an integral and indispensable portion for a resonant element or a resonant unit of the present disclosure.

In addition to the method of die casting mentioned in the above, there are a variety of production technologies available for manufacturing the resonant elements or resonant units independently with respect to the partition walls (for example, as explained with respect to the first through fifth examples of the main body) or forming the resonant elements or resonant units integrally with the partition walls or even the filter frame as well (as explained with respect to the sixth example of the main body). For example, metal injection molding and plastic injection molding are applicable for manufacturing resonant elements or resonant units or the filter. It is also possible that the resonant elements or resonant units can be made of other materials than metal (such as, aluminum, copper, iron, steel, etc.), for example, plastics. In that case, electroplating or conductive oxidation treatment may be needed for carrying out a surface metallization treatment on non-metal elements. The resonant elements or resonant units may be made of materials same to or different from the material for the filter frame. Therefore, the resonant elements or resonant units can be manufactured with high efficiency and low cost. All metal parts of the filter can be replaced with non-metal components which are subject to a surface-metallization treatment, for example, silver plated plastic plate or sheet-like component.

The top cover 50 or the bottom plate 60 may be attached to the filter frame 20 by laser welding and reflow welding technology, so that the resonant elements or resonant units are well enclosed.

Although it is shown in the drawings that the resonant elements are arranged in a pair and both the first resonant unit and the second resonant unit are provided in the accommodation space of the filter, it can be understood that the number of the resonant elements for a filter can be odd, and that the number of first or second resonant units for a filter or their arrangements can be varied according to specific requirements on signal transmission in the filter.

Although it is shown that resonant end parts in one resonant element or one resonant unit or in a filter are designed in a same shape, it can be understood that their shapes can be designed differently. This will increase the flexibility of manufacturing and designing a filter, for example, a sheet metal filter, and also allows modifying in a simple and easy manner.

According to the present disclosure, integration of resonators and high integration of resonators with the partition walls and/or the filter frame make it possible to manufacture a miniaturized filter with high debugging and production efficiency, improved consistency, flexibility and reliability, reduced weight, and low insertion loss and low cost.

The term “cross-coupling arm” used refers to all the arm-like portions extending from the main body of the resonant element and intended to form a cross-coupling with a matching resonator that is not adjacent, along the main signal transmission path, to resonators formed by the resonant element concerned. The matching resonator can be embodied as a resonator formed by another resonant element or as a resonator with a matching cross-coupling arm or the like.

In the description of the present disclosure, it should be understood that the orientation or position relationship indicated by the terms “up/upper”, “down/downwards”, “top”, “bottom”, “inward”, “outward”, “horizontal”, “vertical” and so on is based on the orientation or position relationship when the filter is placed in a position as shown in FIG. 1, only for the convenience of describing the invention and simplifying the description, rather than indicating or implying that the filter or element must have a specific orientation, or must be constructed and operated in a specific orientation. They should not be interpreted as limitative for the inventions revealed in the present disclosure.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A one-piece resonant element (100, 100′) for a filter (10), comprising:
a main body (100-12, 100′-12) which comprises an elongate middle part (100-1, 100′-1) and resonant end parts (100-2, 100′-2) provided on both ends of the middle part (100-1, 100′-1),
wherein the one-piece resonant element further comprises a cross-coupling arm (100-3, 100′-3, 100′-3i) extending integrally from the middle part (100-1, 100′-1) and configured for creating inductive or capacitive cross-coupling with a resonator that is located on a signal transmission path of the filter.

2. The one-piece resonant element (100, 100′) according to claim 1, characterized in that the main body (100-12, 100′-12) of the one-piece resonant element is substantially flat.

3. The one-piece resonant element (100, 100′) according to claim 2, characterized in that the resonant end parts (100-2, 100′-2) each have a thickness greater than or equal to a thickness of the middle part (100-1, 100′-1).

4. The one-piece resonant element (100, 100′) according to claim 2, characterized in that the cross-coupling arm (100-3, 100′-3, 100′-3i) extends from a widthwise end side of the middle part (100-1, 100′-1) of the resonant element (100, 100′).

5. The one-piece resonant element (100, 100′) according to claim 1, characterized in that a free end of the cross-coupling arm (100-3) has a bending part (100-30) which is configured to provide a coupling face for coupling with the resonator.

6. The one-piece resonant element (100, 100′) according to claim 1, characterized in that a free end of the cross-coupling arm (100-3) is configured to provide a coupling end surface for coupling with the resonator.

7. The one-piece resonant element (100, 100′) according to claim 2, characterized in that the resonant end parts (100-2, 100′-2) of the resonant element (100, 100′) each comprise a widened portion (100-2a, 100′-2a) relative to the middle part (100-1, 100′-1).

8. The one-piece resonant element (100, 100′) according to claim 7, characterized in that at least one widened portion (100-2a, 100′-2a) is provided with a hole (100-20, 100′-20) for receiving a tuning screw on its planar side.

9. The one-piece resonant element (100, 100′) according to claim 7, characterized in that a bending lug (100-2b-2, 100′-2b-2) is provided on at least one widthwise end of the widened portion (100-2a-2, 100′-2a-2) of one resonant end part and extends substantially in a direction of the other resonant end part.

10. The one-piece resonant element (100, 100′) according to claim 1, characterized in that at least one of the resonant end parts (100-2-4) is provided with a planar extension portion (100-2a-4) in its end area, the planar extension portion extending in a plane substantially perpendicular to a lengthwise direction of the middle part (100-1-4) for providing a coupling surface.

11. The one-piece resonant element (100, 100′) according to claim 1, characterized in that the resonant element is made of metal or surface metallized.

12. A resonant unit (200, 200′) comprising:
at least two one-piece resonant elements (100, 100′) according to claim 1,
wherein a coupling gap (100-31) is formed between a cross-coupling arm (100-3) of a first resonant element and a cross-coupling arm (100-3) of a second resonant element, or the cross-coupling arms (100′-3) of the first resonant element and the second resonant element are, as separate arms, connected into one, or defined by one single one-piece arm (100′-3i) integrally formed with the main bodies of the first and second resonant elements.

13. The resonant unit (200, 200′) according to claim 12, characterized in that the main bodies (100-12, 100′-12) of the first resonant element and the second resonant element are in basically the same shape.

14. The resonant unit (200, 200′) according to claim 12, characterized in that the main bodies (100-12, 100′-12) of the first resonant element and the second resonant element are placed in basically one and the same plane.

15. The resonant unit (200) according to claim 12, characterized in that the coupling gap (100-31) is defined between coupling surfaces that are provided by bending parts (100-30) at free ends of the cross-coupling arms and located opposite to each other, with bending parts extending in a same direction or in different directions.

16. The resonant unit (200) according to claim 12, characterized in that the coupling gap (100-31) is defined between side surfaces that are opposite to each other, of the cross-coupling arms (100-3).

17. A filter (10, 10′), comprising:
a filter frame (20) in which an accommodation space is formed,
partition walls (30) provided in the accommodation space and dividing the accommodation space into resonant cavities;
at least one resonant element (100, 100′) according to claim 1 arranged in the accommodation space in such a manner that each resonant element functions as two resonators that are adjacent to each other along the signal transmission path, with its middle part extending across a partition wall between two adjacent resonant cavities for the two resonators.

18. The filter (10, 10′) according to claim 17, characterized in that an isolation channel (30-3, 30′-3) for receiving cross-coupling arms (100-3, 100′-3, 100′-3i) is defined by partition walls.

19. The filter (10, 10′) according to claim 17, characterized in that the resonant element (100, 100′) is supported by a partition wall across which it extends.

20. The filter (10, 10′) according to claim 19, characterized in that an attaching means (80) is provided on the middle part (100-1-3, 100-1-4, 100-1-5) of the resonant element for attaching the middle part onto the partition wall across which the middle part extends.

21-22. (canceled)
